(19) United States
(12) Patent Application Publication
(10) Pub. No.: US 2007/0063527 A1
(43) Pub. Date: Mar. 22, 2007

(54) Movable body opening and closing control apparatus

(75) Inventors: Shigeki Ueda, Yamatokohriyama-shi (JP); Hiroyuki Ogino, Nara-shi (JP)

Correspondence Address: PEARNE & GORDON LLP, 1801 EAST 9TH SRTEET, SUITE 1200, CLEVELAND, OH, 44114-3108, US

(73) Assignee: Matsushita Electric Industrial Co., Ltd., Osaka (JP)

(21) Appl. No.: 10/556,847

(22) PCT Filed: May 12, 2004
(86) PCT No.: PCT/JP04/06702

§ 371 Date: Nov. 14, 2005

(30) Foreign Application Priority Data
May 15, 2003 (JP) 2003-136971
May 15, 2003 (JP) 2003-136970

(51) Int. Cl. B62D 25/00

(52) U.S. Cl. 296/55

(57) ABSTRACT

In a movable body opening and closing control apparatus of the invention, a problem is to perform safely an abrupt closing operation of a movable body in the middle of opening the same.

With a view to solving the problem, a movable body opening and closing control apparatus of the invention includes a movable body provided in an opening in a main body in such a manner as to be freely opened and closed, a drive means (4) for driving the movable body, an input means (1) for commanding the movable body to be opened and closed, a flexible cable-shaped piezoelectric sensor (29) for detecting a trapping caused by the movable body, and a control unit (35) for controlling these driving means, input means and piezoelectric sensor, wherein when a command to close the movable body is generated from the input means (1) while the movable body is being opened, the control unit (35) controls such that a closing operation is delayed until the movable body reaches a predetermined opened position, whereby the operator is allowed to see outside the movable body for confirmation against an abrupt command to close the movable body in the middle of opening the same, thereby making it possible to prevent a trapping by the movable body.

### TECHNICAL FIELD

The present invention relates to a movable body opening and closing control apparatus for self-running devices, automotive power windows, electric sliding doors and electric sunroofs, automatic doors of buildings and the like, and more particularly to opening and closing control of a movable body when the movable body receives a closing command while being opened.

### BACKGROUND ART

In recent years, equipment for automatically opening and closing a movable body by a drive source such as a motor is on the increase. While elevator doors and automatic exit and entrance doors of buildings are well known as equipment and systems of this type, in recent automobiles, models are on the increase in which a heavy sliding door and a back door are biased by motors to open and close through a switch operation without involving any manual operation. It is raised as a background for this trend that users' preferences are diversified from sedans, which have been the center of interest of users, to one box cars and recreational vehicles. In addition, it is also one of the reasons for the trend that a case is increasing where female drivers drive such large passenger vehicles which are generally tall in height and increasingly feel it difficult for them to manually open and close heavy sliding doors and back doors which are positioned high when opened.

Conventionally, an example has been known as an opening and closing control apparatus for movable bodies of this type in which a trapping detecting switch sensor made of a conductive rubber is provided on an automotive automatic back door (refer, for example, to Patent Document No. 1).

In addition, an example is disclosed in which a trapping detecting switch sensor made of a conductive rubber is provided on an automotive automatic sliding door (refer, for example, to Patent Document No. 2).

Either of the two examples is such as to detect a trapping of part of the human body and a foreign matter between the door and the vehicle body when such a trapping occurs while the door is being biased to be closed by the motor so as to open the door to secure safety.

There has been described a circuit configuration as shown in FIG. 7 as a control circuit in the conventional movable body opening and closing control apparatus like these. Aback door switch 1 is provided on a driver's seat of the vehicle and/or an ignition key and sends operation commands to open and close the back door to a computer 2 as a control unit in a wired or wireless fashion. The computer 2 receives such operation commands from the back door switch 1 and drives a back door motor 4 forwards and backwards or stops the motor via a driver 3. The driver 3 is fed from a battery 5 and drives the back door motor 4.

In addition, a closer assembly is disposed on the vehicle side which pulls in the door and locks it. The closer assembly is made up of a closer motor 6 as a drive means and a pair of junctions 7, 8. The junctions 7, 8 are provided in such a manner as to be connected to each other in a state directly before the back door swings downwards to be fully closed. The junction 7 is connected to the computer 2 to input into the computer 2 a signal generated when the junction 7 and the junction 8 are connected together. Then, the computer 2 stops the back door motor 4 via the driver 3 and drives the closer motor 6 via another driver 9. The closer motor 6 moves the back door to a fully closed position to lock the door via a lock means which makes up the closer assembly.

The configuration can be realized on the vehicle by this configuration in which the back door is rotated so as to be automatically opened and closed by virtue of the drive forces of the back door motor 4 and the closer motor 6 only through the operation of the back door switch 1.

In addition, in this related art, a pressure sensor 10 is provided to detect a trapping of a foreign matter between the back door and the vehicle body and then inputs such a fact into the computer 2 via a current detecting device 11. A sensor shown in FIG. 8 which utilizes a conductive rubber is used as the pressure sensor 10. The pressure sensor 10 has a circular cross section and is made up of a skin portion 12 made of an insulating elastic material such as rubber and soft synthetic resin materials and four electrode wires 13, 14, 15, 16 which are disposed substantially in a spiral fashion along a longitudinal direction. According to this configuration, when the skin portion 12 is elastically deformed, the electrode wires 13 to 16t are deflected to be brought into contact with each other and are then allowed to electrically communicate with each other.

(Patent Document No. 1)

JP-A-2002-242535

(Patent Document No. 2)

JP-A-2002-235480

In addition, in recent years, equipment for automatically opening and closing a movable body by a drive source such as a motor is on the increase. While elevator doors and automatic exit and entrance doors of buildings are well known as equipment and systems of this type, in recent automobiles, models are on the increase in which a heavy sliding door and a back door are biased by motors to open and close through a switch operation without involving any manual operation. It is raised as a background for this trend that users' preferences are diversified from sedans, which have been the center of interest of users, to one box cars and recreational vehicles. In addition, it is also one of the reasons for the trend that a case is increasing where female drivers drive such large passenger vehicles which are generally tall in height and increasingly feel it difficult for them to manually open and close heavy sliding doors and back doors which are positioned high when opened.

Conventionally, in automotive automatic sliding doors, there has been disclosed a configuration which can prevent the trapping of a foreign matter even in the event that the moving speed of the sliding door changes when opened and closed and the foreign matter is small by detecting the change and the foreign matter, which is small, by controlling the opening and closing of the sliding door while detecting the position thereof (refer, for example, to Patent Document No. 3).

FIG. 18 is a perspective view of a vehicle 101 provided with such an automatic sliding door and FIG. 20 is a block diagram for controlling the opening and closing of the same door. A sliding door 102 is provided on the vehicle 101. This sliding door 102 is disposed to close an opening 103 which is formed in a side rear portion of the vehicle 101 for ingress and egress of passengers.

In addition, a sliding mechanism 104 for enabling the longitudinal sliding of the door is provided at a lower end of the sliding door 102. The sliding mechanism 104 is made up of a bracket and a roller rotatably supported at a distal end portion thereof, and a guide rail which is to be brought into abutment with the roller, and the roller is designed to move along the longitudinal direction of the vehicle 101 while rolling on the guide rail.

A belt 105 fixed to the bracket is extended between a pulley 106 and a drive roller 107. The drive roller 107 rotates the belt 105 by means of a sliding motor (not shown) as a drive means provided on a sliding actuator 108. When the belt 105 is rotated, the bracket contained in the sliding mechanism 104 is moved, and the roller rolls along the guide rail, whereby the sliding door 1021 is moved.

In addition, as shown in FIG. 20, the sliding actuator 108 includes a sliding driver 109 and connects the sliding door 110 to a computer 111 via the sliding driver 109. In addition, a control switch 112 (refer to FIG. 18) provided near a driver's seat of the vehicle 101 is also connected to the computer 111, whereby a signal to open or close the sliding door 102 is inputted into the computer 111 by operating the control switch 112 so as to actuate the sliding actuator 108, so that the sliding door 102 can be opened or closed.

Furthermore, the automatic sliding door includes a closer actuator 113. This closer actuator 113 is disposed within the sliding door 102, has a closer motor 114 and is connected to the computer 111 via a closer driver 115. This closer motor 114 is driven by the computer 111 after the sliding motor 110 has been rotated .until directly before the sliding door 102 has closed the opening 103 and locks the door at a closed position.

In addition, the sliding actuator 108 includes a door position detector. The position detector includes a disc portion having a plurality of projections on provided radially on an outer circumferential portion thereof at predetermined intervals which rotates while reducing the drive force of the sliding motor 110. Then, when a pulse counter 116 counts the projections, the computer 111 can detect an opened position of the sliding door 102 from the number of pulses so counted as shown in FIG. 19. Narnely, it is possible to know whether the sliding door 102 is in an acceleration region denoted by A where the sliding door 102 has started to move from a fully opened position, in a constant speed region denoted by B where the sliding door 102 has reached the constant speed, in a deceleration region denoted by C where the sliding door 102 has started to decelerate to be prepared for closing, or in a closer region denoted by D where the sliding door 102 is locked at the closed position.

The computer 111 ensures the detection of trapping by driving a speed change detecting device 117 which detects a change in rotational speed of the motor or a pressure sensor 118 for each position. Narnely, in the constant speed region denoted by B, the speed change detecting device 117 and the pressure sensor 118 are used in parallel with each other to complement each other's week points. Then, in the acceleration region denoted by A and the deceleration region denoted by C, since the speed of the sliding door 102 is low, the computer 111 ignores output from the speed change detecting device 117. In the closer region denoted by D, while the closer motor 114 starts to operate, a foreign matter detection by the pressure sensor 118 is possible.

(Patent Document No. 3)

JP-A-11-190168

### DISCLOSURE OF THE INVENTION

In the conventional movable body opening and closing control apparatuss, however, there remains a problem with a closing operation in the middle of opening the door. Namely, in the sliding door or the like, when an abrupt command to close the sliding door is given from the driver's seat in the middle of operating the door to open, there exists a possibility that the driver performs a door closing operation without being aware of a person behind the door. In particular, when the person is a small child, the driver cannot see him or her through a window encompassed in the door. In addition, there exists a risk that the child pushes in his or her arm in an attempt to ride on the vehicle through the opening door.

In addition, even with the conventional pressure sensor shown in FIG. 8 that is provided to avoid a risk like this, it is difficult to obtain an enough stroke for the skin portion 12 to be elastically deformed in the aforesaid case where the sliding door is attempted to be closed after it has been opened slightly, and hence there exists a problem that the pressure sensor cannot provide a sufficient sensitivity to sense the trapping of a soft and thin object.

The invention has been made to solve the problems inherent in the related art, and an object thereof is to provide a movable body opening and closing control apparatus which ensures the detection of a trapping by a door that would occur when an abrupt command to close the door is given while the door is being opened.

With a view to attaining the object, in a movable body opening and closing control apparatus according to the invention, even when an abrupt command to close a door is given while the door is being opened, a door closing operation is delayed until the door reaches a predetermined opened position.

By this configuration, even when the driver has to give an abrupt command to close the door while it is being opened, the driver is allowed to see outside the door for confirmation, thereby making it possible to prevent a risk of trapping by the door.

In addition, by providing a flexible cable-shaped piezoelectric sensor, the detection of a trapping by the door can be ensured by detecting the vibration of the door by the piezoelectric sensor together with the delayed door closing operation.

On the other hand, in the conventional movable body opening and closing control apparatuss, however, there remains a problem with a closing operation in the middle of opening the door. Namely, in the sliding door or the like, when an abrupt command to close the sliding door is given from the driver's seat in the middle of operating the door to open, there exists a possibility that the driver performs a door closing operation without being aware of a person behind the door. In particular, when the person is a small child, the driver cannot see him or her through a window encompassed in the door. In addition, there exists a risk that the child pushes in his or her arm in an attempt to ride on the vehicle through the opening door.

The invention has been made to solve the problems inherent in the related art, and an object thereof is to provide a movable body opening and closing control apparatus which ensures the detection of a trapping by a door that would occur when an abrupt command to close the door is given while the door is being opened.

With a view to attaining the object, in a movable body opening and closing control apparatus according to the invention, even when an abrupt command to close a door is given while the door is being opened, a door closing operation is delayed until the door reaches a predetermined opened position.

By this configuration, even when the driver has to give an abrupt command to close the door while it is being opened, the driver is allowed to see outside the door for confirmation, thereby making it possible to prevent a risk of trapping by the door.

### BRIEF DESCRIPTION OF THE DRAWINGS

FIG. 1 is a perspective view of a movable body opening and closing control apparatus according to Embodiment 1 of the invention,

FIG. 2 is a perspective view which shows a state in which a door is opened under the system,

FIG. 3 is a sectional view of a main part of the system which shows a state in which a sensor is actually installed thereon,

FIG. 4 is a perspective view in part which shows a detailed configuration of a piezoelectric sensor of the system,

FIG. 5 is a block diagram which shows a system configuration of the system,

FIG. 6 is a timing chart of the system,

FIG. 7 is a block diagram which shows a system configuration of a conventional movable body opening and closing control apparatus,

FIG. 8 is a perspective view in part which shows a detailed configuration of a sensor of the conventional movable body opening and closing control apparatus,

FIG. 9 is a sectional view of a main part of Embodiment 2 of the invention which shows a state in which a sensor is actually installed thereon,

FIG. 10 is a perspective view of a movable body opening and closing control apparatus according to Embodiment 3 of the invention,

FIG. 11 is a perspective view of a movable body opening and closing control apparatus according to Embodiment 4 of the invention,

FIG. 12 is a perspective view of a movable body opening and closing control apparatus according to Embodiment 5 of the invention,

FIG. 13 is a perspective view which shows a state in which a door is closed under the system,

FIG. 14 is a sectional view of a main part of the system which shows a state in which a sensor is actually installed thereon,

FIG. 15 is a perspective view in part which shows a detailed configuration of a piezoelectric sensor of the system,

FIG. 16 is a block diagram which shows a system configuration of the system,

FIG. 17 is a timing chart of the system,

FIG. 18 is a perspective view of a conventional movable body opening and closing control apparatus,

FIG. 19 is a diagram which shows regions where a door is positioned when opened under the conventional movable body opening and closing control apparatus,

FIG. 20 is a block diagram which shows a system configuration of the conventional movable body opening and closing control apparatus,

FIG. 21 is a sectional view of a main part of Embodiment 6 of the invention which shows a state in which a sensor is actually installed thereon,

FIG. 22 is a perspective view of a movable body opening and closing control apparatus according to Embodiment 7 of the invention, and

FIG. 23 is a perspective view of a movable body opening and closing control apparatus according to Embodiment 8 of the invention.

Note that in the figures, reference numeral 1 denotes a back door switch, 18 a back door, 26 a bracket, 28 a protector, 29 a piezoelectric sensor, 35 a control unit, 137 a back door switch, 120 a back door, and 138 a control unit.

### BEST MODE FOR CARRYING OUT THE INVENTION

A movable body opening and closing control apparatus of the invention has a movable body provided in an opening in a main body in such a manner as to be freely opened and closed, a drive means for driving the movable body, an input means for commanding the movable body to be opened and closed, a detecting means for detecting a trapping of an object between the movable body and the main body and a control unit for controlling the opening and closing of the movable body. Then, when a command to close the movable body is given from the input means while the movable body is being opened, the control unit controls such that a closing operation is delayed until the movable body reaches a predetermined opened position in order to make it difficult for a trapping to be caused by an abrupt command to close the movable body given while it is being opened.

The movable body opening and closing control apparatus of the invention has a sliding door or a back door provided on an automobile as the movable body and the input means provided on a driver's seat of the automobile. Then, when a command to close the sliding door or the back door is given from the input means while the sliding door or the back door is being opened, the control unit controls such that a closing operation is delayed until the movable body reaches a predetermined opened position so that the driver can see outside the door for confirmation.

The movable body opening and closing control apparatus of the invention has a flexible cable-shaped piezoelectric sensor as the detecting means. Then, a trapping that would occur between the movable body and the main body can be detected with good sensitivity.

In the movable body opening and closing control apparatus of the invention, the control unit has a counter means adapted to start counting at a point in time where an opening command is given from the input means. Then, when an abrupt command to close the movable body is given while it is being opened, the control unit controls such that the sending of a command to start a closing operation to the driving means is delayed until the counter means completes the counting of a predetermined period of time irrespective of the abrupt command to close the movable body so given so as to prevent the occurrence of trapping.

In the movable body opening and closing control apparatus of the invention, the sensor has a detection circuit which includes a filter for removing noise. Then, when an abrupt command to close the movable body while it is being opened, in order to prevent the occurrence of trapping, the control unit has a counter means adapted to start counting at a point in time where an opening command is given from the input means to thereby control such that the sending of a command to start a closing operation to the driving means is delayed at least until the counter means completes the counting of a predetermined period of time which exceeds a rising time based on a time constant of the detection circuit irrespective of the abrupt command to close the movable body so given.

Hereinafter, Embodiments 1 to 4 of the invention will be described using the drawings.

(Embodiment 1)

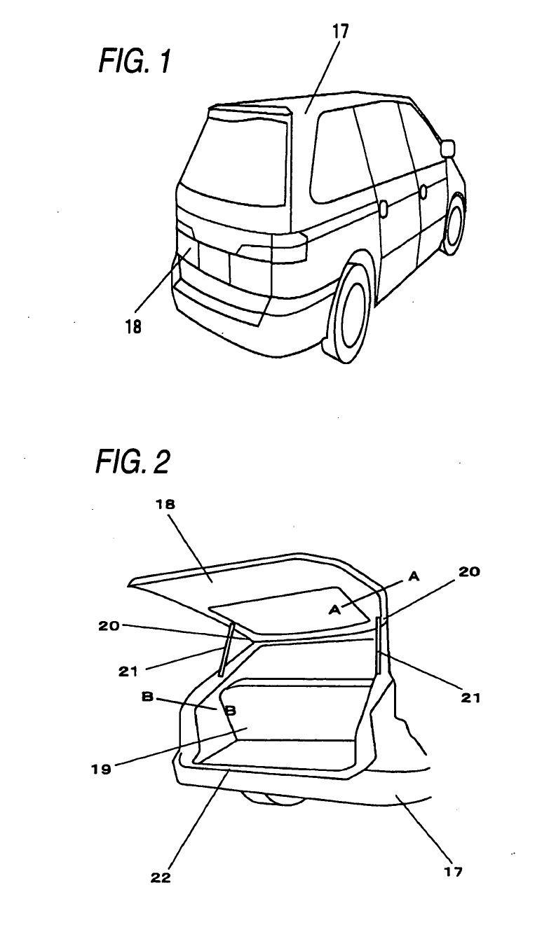

FIGS. 1 to 6 show a movable body opening and closing control apparatus according to Embodiment 1 of the invention and an application example thereof.

FIG. 1 is a perspective view of a vehicle in which the invention is installed on a back door thereof as a movable body. A back door 18 is provided at the rear of a vehicle body 17 in such a manner as to be freely opened and closed.

FIG. 2 is a perspective view which shows a state in which the back door 18 is opened. When the back door 18 is opened, a luggage space (a luggage compartment) 19 is formed so that luggage or the like can be loaded into and unloaded from the interior of the vehicle. The back door 18 is rotatably supported by hinges 20 (not shown) in the vicinity of an upper end thereof and is rotated by a back door motor (not shown). The back door 18 is supported by dampers 21. The dampers 21 are each made up of a cylinder and a piston and are provided to absorb impact resulting when the back door 18 is opened and closed so as to allow the back door 18 to be opened and closed smoothly. An opening 22 in the vehicle body 17 which oppositely faces the back door 18 is referred to as a rear gateway that closes the interior of the vehicle body 17 when closed by the back door 18.

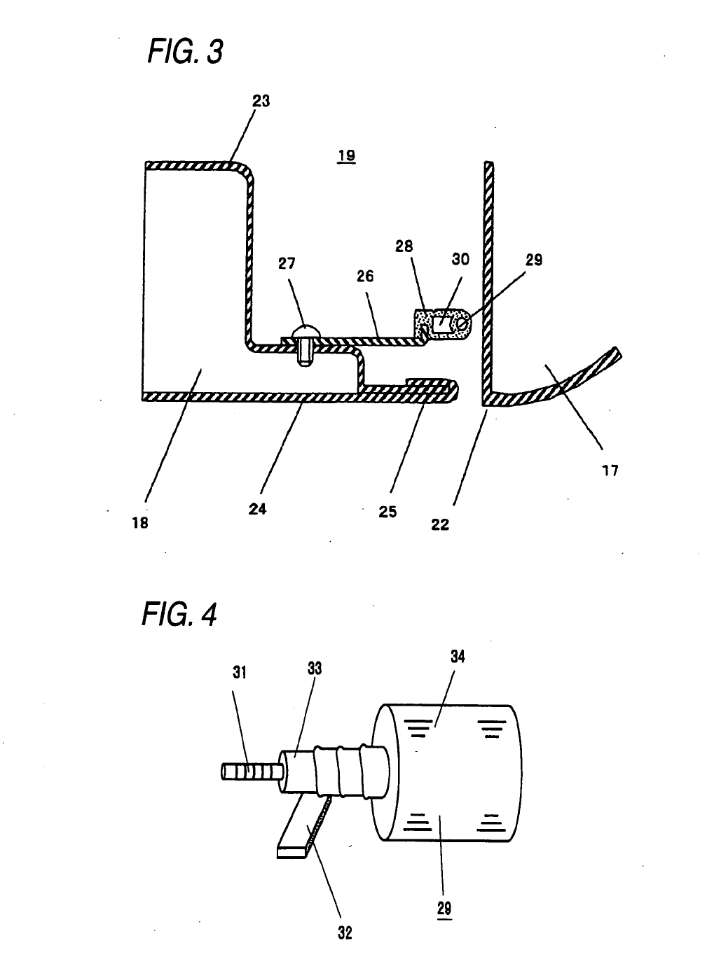

FIG. 3 is a sectional view of an outer circumferential portion of the back door 18 taken along the line A-A and shows a construction in which a sensor is actually installed thereon. The back door 18 is formed by two sheets metal. They are an inner panel 23 which lies on a side of the back door 18 which faces the luggage space 19 and an outer panel 24 which lies on a side thereof which faces the outside of the vehicle. The two panels are constructed such that an end portion of the outer panel 24 is folded on to the inner panel 23 in such a manner as to be brought into mesh engagement therewith along an outer edge portion 25.

While an circumferential edge portion of the back door 18 is made into a thin sheet-like shape having no substantial thickness as shown in the figure by virtue of the aforesaid construction, the inner 23 is formed to expand towards the side of the luggage space 19 at a central portion thereof, whereby the back door 18 has a thickness. A sensor is mounted at this location having the thickness.

A bracket 26 is secured to the thick portion of the back door 18 with a machine screw 17, and a protector 28 is held at one end of the bracket 26. A piezoelectric sensor 29 is provided at a distal end of the protector 28. The piezoelectric sensor 29 is a flexible cable-shaped piezoelectric sensor, and the details thereof will be described later on. The protector 28 elastically holds the piezoelectric sensor 29 and is made of rubber such as EPDM which is more flexible than the piezoelectric sensor 29 or resin such as an elastomer having elasticity. In the embodiment, a hollow portion 30 is provided and is formed so that the piezoelectric sensor 29 easily deflects so as to detect a trapping or collision against the back door 18 with good sensitivity when such occurs. The hollow portion 30 can be replaced by rubber or foamed resin as required.

FIG. 4 is a partially cut away perspective view which shows the details of the piezoelectric sensor 29. The piezoelectric sensor 29 is made up of a center electrode 31, which functions as a signal output electrode, an outer electrode 32, a composite piezoelectric material 33 interposed between both the electrodes and a coating layer 34 and is formed into a cable shape having an outside diameter of on the order of 2.5 mm. Then, the composite piezoelectric material 33 is such as to be molded using a composite piezoelectric material where chlorinated polyethylene is mixed with piezoelectric ceramic powder. This piezoelectric sensor 29 is such as to have a high sensitivity, good durability and good production efficiency and can exhibit its inherent function sufficiently together with the aforesaid configuration of the protector 28, so as to implement a good detection through contact.

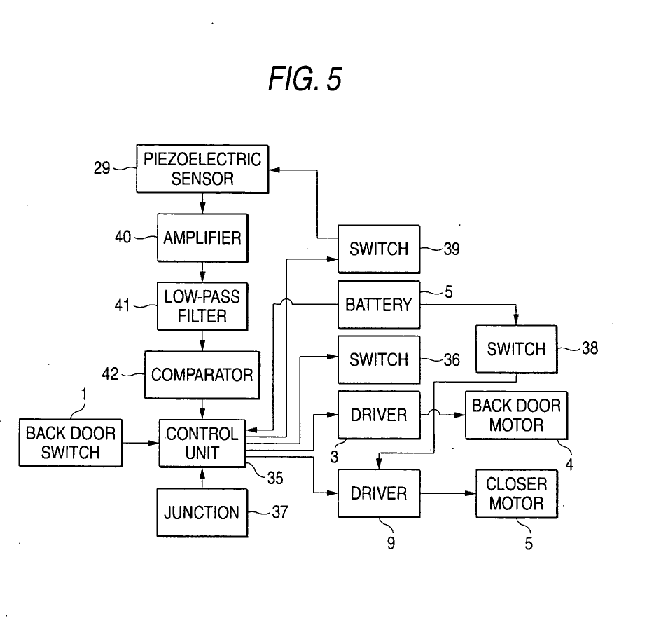

FIG. 5 is a block diagram which shows the configuration of a control apparatus according to the invention. Aback door switch 1 is provided on a driver's seat of the vehicle and an ignition key to send commands of opening and closing operations of the back door to a control unit 35 in a wired or wireless fashion. The control unit 35 is made up of a microcomputer and the like, receives operation commands from the back door switch 1 and drives a back door motor 4 forwards and backwards or stops the motor via a driver 3. The driver 3 is fed from a battery 5 via a switch 36 and drives the back door motor 4. In addition, the switch 35 is ON/OFF controlled by the control unit 35.

In addition, a closer assembly for pulling in the door to lock it is disposed on the side of the vehicle. The closer assembly is made up of a closer motor 6 as a drive means and a junction 37. The junction 37 outputs a closer signal to the control unit 35 directly before the back door is rotated downwards to be fully closed. The control unit 35 can detect that the back door has moved to a closed portion by monitoring this signal.

Then, the control unit 35 stops the back door motor 4 via the driver 3 and drives the closer motor 6 via another driver 9. The closer motor 6 moves the back door to a fully closed position to lock the door via a locking means which makes up the closer assembly. The driver 9 is also fed from the battery 5 via a switch 38 so as to drive the closer motor 6.

The battery 5 further feeds the piezoelectric sensor 29 via a switch 39 and also feeds, of course, the control unit 35. The control unit 35 can freely control the feeding to the piezoelectric sensor 29, the back door motor 4 and the closer motor 6 by these switches 35, 38, 39.

An output signal of the piezoelectric sensor 29 is amplified to a predetermined magnification by an amplifier 40, is then inputted into a low-pass filter 41 to take out only a contact signal, is compared with a certain threshold at a comparator 42 after noise has been removed therefrom to determine whether or not a trapping and a collision has occurred and is finally inputted into the control unit 35.

Now then, how to control a case will be described in which the operator on the driver's seat inputs an abrupt command to close the back door from the back door switch 1 that is provided on the driver's seat of the vehicle under the aforesaid configuration at a point in time where a command to open the back door has been inputted into the control unit 35 from the back door switch 1, whereby the back door has started to open according to the aforesaid procedures. Cases are considered as the case like this where the operator, who is the driver in most cases, erroneously operates the back door switch and then abruptly gives a command to close the door or the driver operates initially the switch in an attempt to open the door but thereafter changes his or her mind or suddenly becomes concerned about another issue.

In such a case, the closer motor 6 starts to operate based on the initial operation of the back door switch 1, and normally it takes on the order of a second to release the lock. Thereafter, the back door motor 4 starts to rotate forwards and the back door then starts to open. It is natural that the initial speed of the door being opened is at a small value. Consequently, in the event that the back door switch 1 is operated continuously, there is a case where the back door motor 4 starts to rotate backwards to move the back door in a closing direction only after the back door has opened from only several millimeters to several centimeters. While a case like this is most dangerous, considering the importance of the intention of the operator, the second command to close the back door cannot be ignored.

Then, in the invention, the control unit 35 has a delay function for an operation command from the back door switch 1. To be specific, the control unit 35 has a counter means adapted to start counting at a point in time where a command to open the back door is given from the back door switch 1 and controls such that the sending of a command to start a closing operation to the back door motor 4 is delayed until the counter means completes the counting of a predetermined period of time irrespective of the command to close the back door so given.

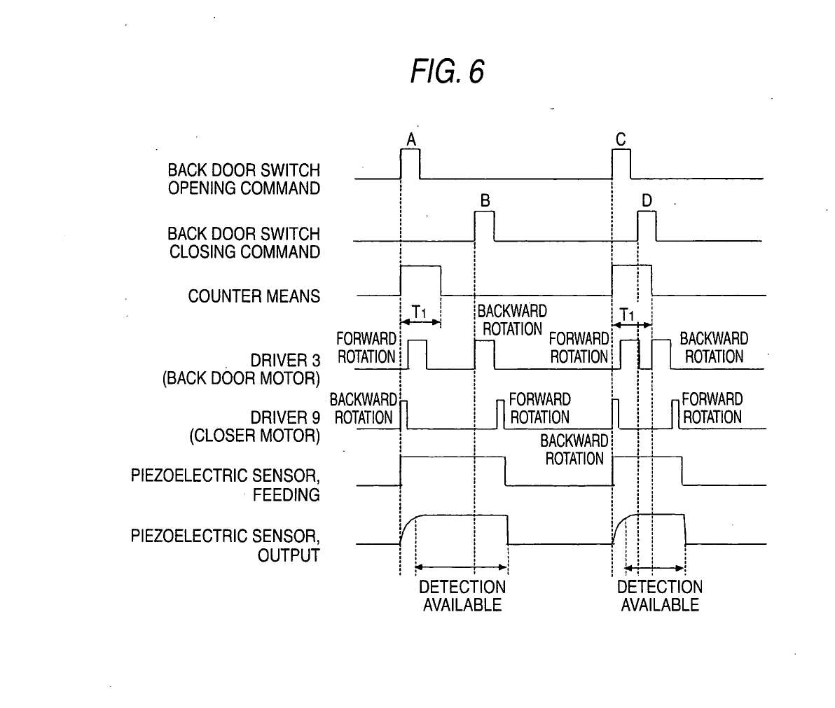

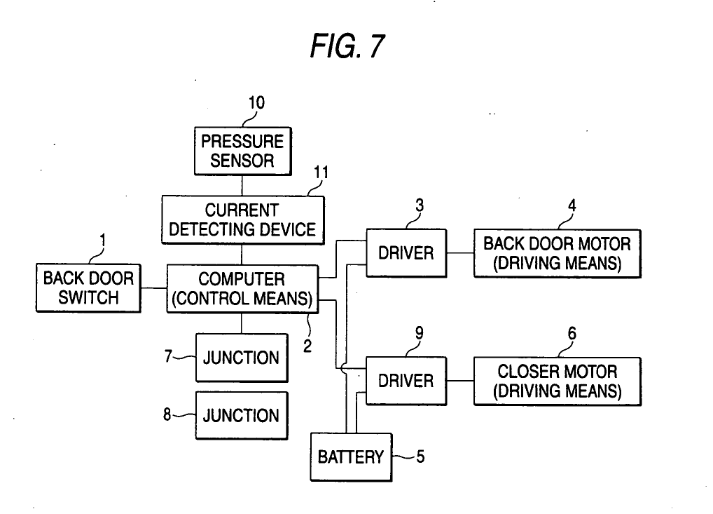

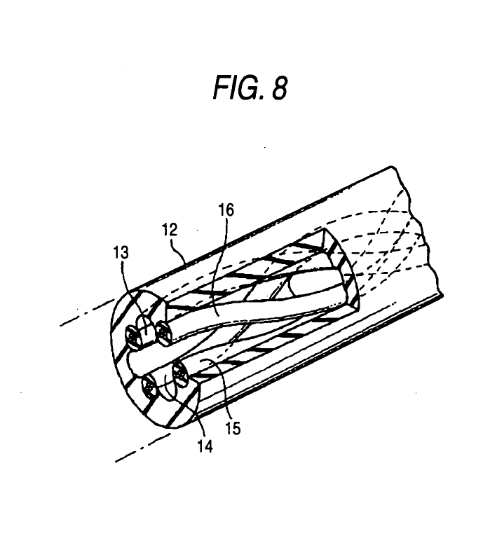

FIG. 6 is a time chart which shows how the control unit 35 controls under the system described heretofore.

The back door switch inputs a command A to open the back door and a command B to close the back door. This is normally a pair of operations, and since goods are loaded and unloaded in a state where the back door is opened, it is general that a sufficient time elapses between the door opening command A and the door closing command B.

The control unit rotates the closer motor backwards via the driver 9 by the door opening command A of the back door switch, whereby the back door is released from a closed position where the back door is locked. In connection with this, the counter means starts counting. Then, a predetermined period of time T1 is counted. Then, the back door motor is rotated forwards via the driver 3 so as to move the back door in an opening direction.

As has been described previously, since the sufficient time has elapsed between the normal opening and closing operations, this time T1 has elapsed completely at a point in time where the door closing command B is inputted. Consequently, the door closing command B is executed as it is, whereby the control unit rotates the back door motor backwards via the driver 3 so as to move the back door in the closing direction. Then, the control unit rotates the closer motor forwards via the driver 9 so as to lock the back door at the closed position.

The control unit starts feeding the piezoelectric sensor at a point in time where the control unit receives the door opening command A. An output from the piezoelectric sensor can be detected after a slight lapse of time as a rising time. While there is no risk that a trapping occurs while the back door is being opened, by energizing the sensor while the back door is being opened, and in particular, by utilizing the cable-shaped piezoelectric sensor for the sensor, it becomes possible to detect a contact of the back door with a human being, a foreign matter and part of a building such as a ceiling in the middle of opening the back door. Namely, since the back door vibrates largely due to such a contact, the piezoelectric sensor, which is a type of sensor for detecting vibrations, can detect the contact of the back door. In this case, since the control unit stops the back door motor via the driver 3 so as to interrupt the further movement of the door in the opening direction,.it is extremely safe.

Next, how to control a case will be described in which a command C to open the back door and a command D to close the same door are inputted continuously within a short period of time.

Firstly, when the door opening command C is inputted, the command is executed as it is, whereby the control unit rotates the closer motor backwards via the driver 9, so that the back door is released from the closed position where the back door is locked. In connection with this, the counter means starts counting. Then, the predetermined period of time TI is counted. Next, the back door motor is rotated forwards via the driver 3 so as to drive the back door in the opening direction.

In relation to the door closing command D that is inputted in succession, since the counter means has not completed the counting of the predetermined period of time T1, the operation to open the back door is delayed until the time T1 has elapsed. Namely, at a point in time where T1 has elapsed, the control unit rotates the back door motor backwards via the driver 3 so as to drive the back door in the closing direction. Then, the control unit rotates the closer motor forwards via the driver 9, whereby the back door is locked at the closed position.

Here, the predetermined period of time T1 that is counted by the counter means is set to a time to produce an opening, for example, a space of several tens of centimeters or larger, which is enough for the driver to confirm whether or not there is standing a person behind the opening back door or whether or not there exists a situation which would trigger a collision and a trapping when he or she turns around to see backwards from the driver's seat.

By this configuration, the driver is allowed to see outside the door for confirmation when he or she gives an abrupt command to close the door while it is being opened, there by making it possible to prevent a risk of trapping by the door.

In addition, by providing the flexible cable-shaped piezoelectric sensor, together with the delayed door closing operation, the detection of a trapping by the door can be ensured by detecting the vibration of the door by the piezoelectric sensor.

(Embodiment 2)

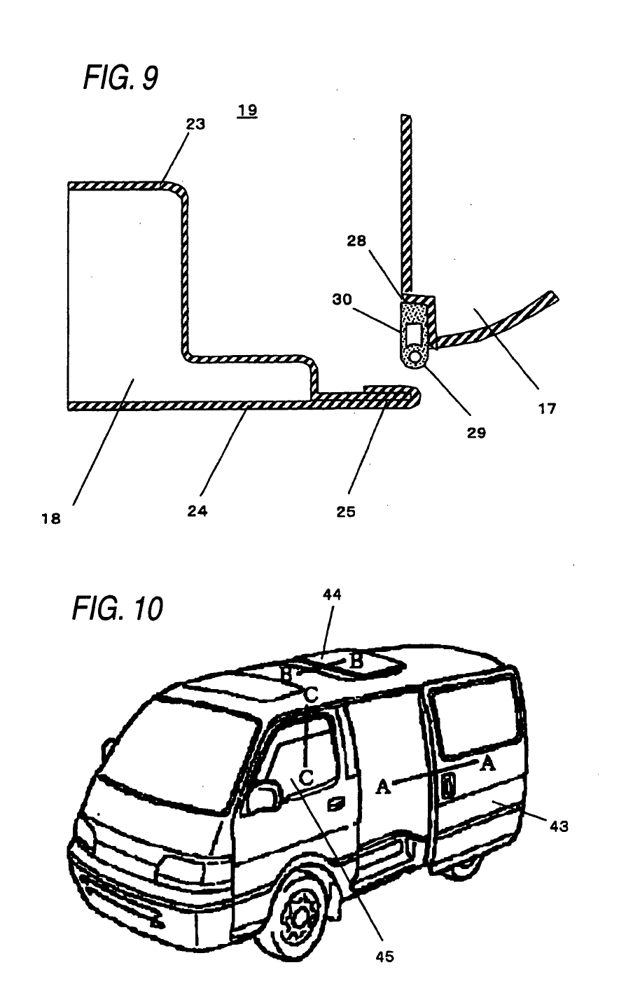

FIG. 9 shows a movable body opening and closing control apparatus according to Embodiment 2 of the invention, and since the basic configuration and function thereof are the same as those of Embodiment 1, only what is different from Embodiment 1 will be described.

In Embodiment 2, what is different from Embodiment 1 resides in that a sensor is provided on a cross section taken along the line B-B in FIG. 2. Namely, the sensor is provided not on the side of the movable body but on the vehicle body which constitutes a fixed side.

In this configuration, since the sensor is provided on the fixed side, the sensor is made difficult to be affected by vibrations of the door generated when the door is opened and closed, thereby making it possible to expect a stable detection.

(Embodiment 3)

FIG. 10 shows a movable body opening and closing control apparatus according to Embodiment 3 of the invention, and since the basic configuration and function thereof are the same as those of Embodiment 1, only what is different from Embodiment 1 will be described.

As shown in the figure, a piezoelectric sensor can be provided on a cross section at one end of a sliding door 43 which is taken along the line A-A. In addition, the invention can be similarly applied to a cross section of a sunroof 44 which is taken along the line B-B. Furthermore, the invention can also be provided on a cross section of a power window 45 which is taken along the line C-C.

In these configurations, the invention can widely be applied not only to the back door but also to the sliding door, sunroof and power window.

(Embodiment 4)

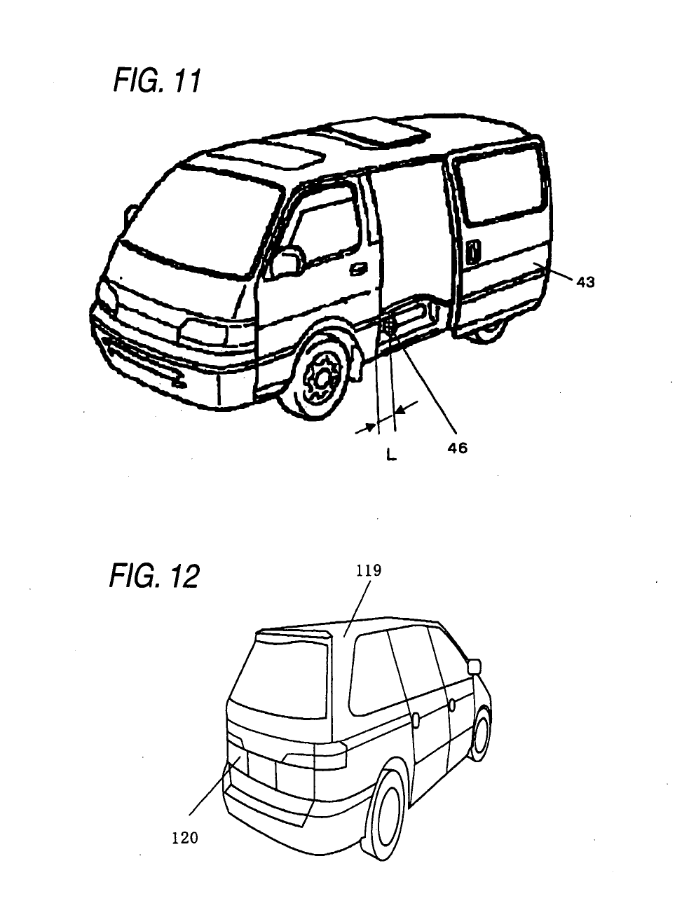

FIG. 11 shows a movable body opening and closing control apparatus according to Embodiment 4 of the invention, and since the basic configuration and function thereof are the same as those of Embodiment 1, only what is different from Embodiment 1 will be described.

Instead of the predetermined period of time T1 which is counted by the counter means in Embodiment 1, there is provided a function to detect whether or not a door has been opened to such an extent that the door has passed a predetermined opened position. Reference numeral 46 denotes a photoelectric switch for performing the function, and a control unit detects at least whether or not a movable body (in this embodiment, a sliding door ) 43 has been opened to such an extent that the movable body has passed a predetermined opened position by the photoelectric switch 46.

In the event that the movable body is determined by the function to detect the opened position as not having been opened to such an extent that the movable body has passed the predetermined opened position when a command to close the movable body is given from the input means in the middle of opening the door, the control unit controls such that a closing operation is delayed until the movable body has reached the predetermined opened position.

By this configuration, the driver is allowed to see outside the door for confirmation against an abrupt command to close the door while it is being opened, thereby making it possible to prevent a risk of trapping by the door.

A movable body opening and closing control apparatus of the invention has a movable body provided in an opening in a main body in such a manner as to be freely opened and closed, a drive means for driving the movable body, an input means for commanding the movable body to be opened and closed, and a control unit for controlling these movable body, drive means and input means. Then, when a command to close the movable body is given from the input means while the movable body is being opened, the control unit controls such that a closing operation is delayed until the movable body reaches a predetermined opened position in order to make it difficult for a trapping to be caused by an abrupt command to close the movable body given while it is being opened.

The movable body opening and closing control apparatus of the invention has a sliding door or a back door provided on an automobile as the movable body and the input means provided on a driver's seat of the automobile. Then, when a command to close the sliding door or the back door is given from the input means while the sliding door or the back door is being opened, the control unit controls such that a closing operation is delayed until the movable body reaches a predetermined opened position so that the driver can see outside the door for confirmation.

In the movable body opening and closing control apparatus of the invention, the control unit has a counter means adapted to start counting at a point in time where an opening command is given from the input means. Then, when an abrupt command to close the movable body is given while it is being opened, the control unit controls such that the sending of a command to start a closing operation to the driving means is delayed until the counter means completes the counting of a predetermined period of time irrespective of the abrupt command to close the movable body so given so as to prevent the occurrence of trapping.

In the movable body opening and closing control apparatus of the invention, the control unit has a function to detect whether or not the position of the movable body has passed a predetermined opened position. Then, when an abrupt command to close the movable body while it is being opened, with a view to preventing a trapping, in the event that the movable body is determined by the function to detect the opened position as not having been opened to such an extent that the movable body has passed the predetermined opened position when the abrupt command to close the movable body while it is being opened is given from the input means, the control unit control such that the occurrence of a closing operation is delayed until the movable body has reached the predetermined opened position.

Hereinafter, Embodiments 5 to 8 of the invention will be described using the drawings.

(Embodiment 5)

FIGS. 12 to 17 show a movable body opening and closing control apparatus according to Embodiment 5 of the invention and an application example thereof.

FIG. 12 is a perspective view of a vehicle in which the invention is installed on a back door thereof as a movable body. Aback door 120 is provided at the rear of a vehicle body 119 in such a manner as to be freely opened and closed.

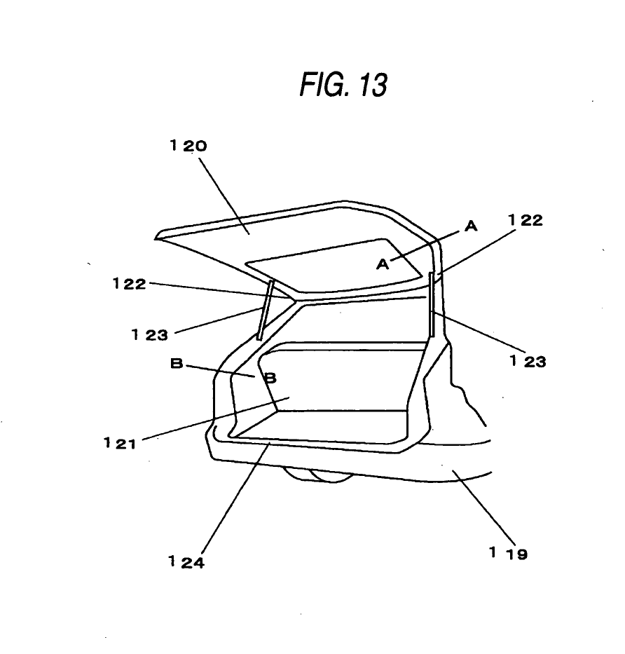

FIG. 13 is a perspective view which shows a state in which the back door 1208 is opened. When the back door 120 is opened, a luggage space (a luggage compartment) 121 is formed so that luggage or the like can be loaded into and unloaded from the interior of the vehicle. The back door 120 is rotatably supported by hinges 1220 (not shown) in the vicinity of an upper end thereof and is rotated by a back door motor (not shown). The back door 120 is supported by dampers 123. The dampers 123 are each made up of a cylinder and a piston and are provided to absorb impact resulting when the back door 120 is opened and closed so as to allow the back door 120 to be opened and closed smoothly. An opening 124 in the vehicle body 119 which oppositely faces the back door 120 is referred to as a rear gateway that closes the interior of the vehicle body 119 when closed by the back door 120.

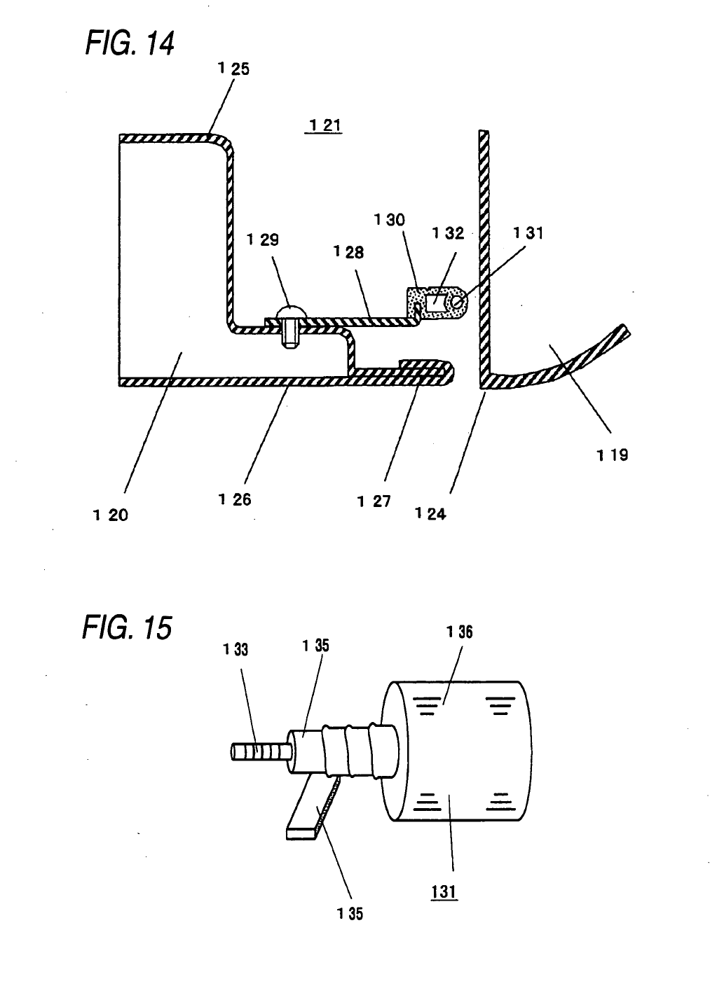

FIG. 14 is a sectional view of an outer circumferential portion of the back door 120 taken along the line A-A and shows a construction in which a sensor is actually installed thereon. The back door 120 is formed by two sheets metal. They are an inner panel 125 which lies on a side of the back door 120 which faces the luggage space 121 and an outer panel 126 which lies on a side thereof which faces the outside of the vehicle. The two panels are constructed such that an end portion of the outer panel 126 is folded on to the inner panel 125 in such a manner as to be brought into mesh engagement therewith along an outer edge portion 127.

While an circumferential edge portion of the back door 120 is made into a thin sheet-like shape having no substantial thickness as shown in the figure by virtue of the aforesaid construction, the inner 125 is formed to expand towards the side of the luggage space 121 at a central portion thereof, whereby the back door 120 has a thickness. A sensor is mounted at this location having the thickness.

A bracket 128 is secured to the thick portion of the back door 120 with a machine screw 129, and a protector 130 is held at one end of the bracket 128. A piezoelectric sensor 131 is provided at a distal end of the protector 130. The piezoelectric sensor 131 is a flexible cable-shaped piezoelectric sensor, and the details thereof will be described later on. The protector 130 elastically holds the piezoelectric sensor 131 and is made of rubber such as EPDM which is more flexible than the piezoelectric sensor 131 or resin such as an elastomer having elasticity. In the embodiment, a hollow portion 132 is provided and is formed so that the piezoelectric sensor 131 easily deflects so as to detect a trapping or collision against the back door 120 with good sensitivity when such occurs. The hollow portion 132 can be replaced by rubber or foamed resin as required.

FIG. 15 is a partially cut away perspective view which shows the details of the piezoelectric sensor 131. The piezoelectric sensor 131 is made up of a center electrode 133, which functions as a signal output electrode, an outer electrode 134, a composite piezoelectric material 135 interposed between both the electrodes and a coating layer 136 and is formed into a cable shape having an outside diameter of on the order of 2.5 mm. Then, the composite piezoelectric material 136 is such as to be molded using a composite piezoelectric material where chlorinated polyethylene is mixed with piezoelectric ceramic powder. This piezoelectric sensor 131 is such as to have a high sensitivity, good durability and good production efficiency and can exhibit its inherent function sufficiently together with the aforesaid configuration of the protector 130, so as to implement a good detection through contact.

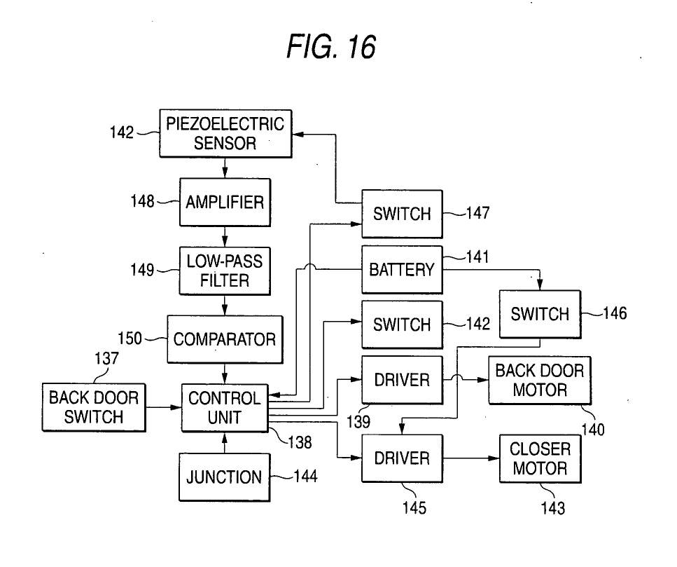

FIG. 16 is a block diagram which shows the configuration of a control apparatus according to the invention. Aback door switch 137 is provided on a driver's seat of the vehicle and an ignition key to send commands of opening and closing operations of the back door to a control unit 138 in a wired or wireless fashion. The control unit 138 is made up of a microcomputer and the like, receives operation commands from the back door switch 137 and drives a back door motor 140 forwards and backwards or stops the motor via a driver 139. The driver 139 is fed from a battery 141 via a switch 142 and drives the back door motor 140. In addition, the switch 142 is ON/OFF controlled by the control unit 138.

In addition, a closer assembly for pulling in the door to lock it is disposed on the side of the vehicle. The closer assembly is made up of a closer motor 143 as a drive means and a junction 144. The junction 144 outputs a closer signal to the control unit 138 directly before the back door is rotated downwards to be fully closed. The control unit 138 can detect that the back door has moved to a closed portion by monitoring this signal.

Then, the control unit 138 stops the back door motor 140 via the driver 139 and drives the closer motor 143 via another driver 145. The closer motor 143 moves the back door to a fully closed position to lock the door via a locking means which makes up the closer assembly. The driver 145 is also fed from the battery 141 via a switch 146 so as to drive the closer motor 143.

The battery 141 further feeds the piezoelectric sensor 131 via a switch 147 and also feeds, of course, the control unit 138. The control unit 138 can freely control the feeding to the piezoelectric sensor 131, the back door motor 140 and the closer motor 143 by these switches 142, 145, 147.

An output signal of the piezoelectric sensor 142 is amplified to a predetermined magnification by an amplifier 148, is then inputted into a low-pass filter 149 to take out only a contact signal, is compared with a certain threshold at a comparator 150 after noise has been removed therefrom to determine whether or not a trapping and a collision has occurred and is finally inputted into the control unit 138.

Now then, how to control a case will be described in which the operator on the driver's seat inputs an abrupt command to close the back door from the back door switch 137 that is provided on the driver's seat of the vehicle under the aforesaid configuration at a point in time where a command to open the back door has been inputted into the control unit 135 from the back door switch 101, whereby the back door has started to open according to the aforesaid procedures. Cases are considered as the case like this where the operator, who is the driver in most cases, erroneously operates the back door switch and then abruptly gives a command to close the door or the driver operates initially the switch in an attempt to open the door but thereafter changes his or her mind or suddenly becomes concerned about another issue.

In such a case, the closer motor 143 starts to operate based on the initial operation of the back door switch 137, and normally it takes on the order of a second to release the lock. Thereafter, the back door motor 140 starts to rotate forwards and the back door then starts to open. It is natural that the initial speed of the door being opened is at a small value. Consequently, in the event that the back door switch 137 is operated continuously, there is a case where the back door motor 140 starts to rotate backwards to move the back door in a closing direction only after the back door has opened from only several millimeters to several centimeters. While a case like this is most dangerous, considering the importance of the intention of the operator, the second command to close the back door cannot be ignored.

Then, in the invention, the control unit 135 has a delay function for an operation command from the back door switch 137. To be specific, the control unit 138 has a counter means adapted to start counting at a point in time where a command to open the back door is given from the back door switch 137 and controls such that the sending of a command to start a closing operation to the back door motor 40 is delayed until the counter means completes the counting of a predetermined period of time irrespective of the command to close the back door so given.

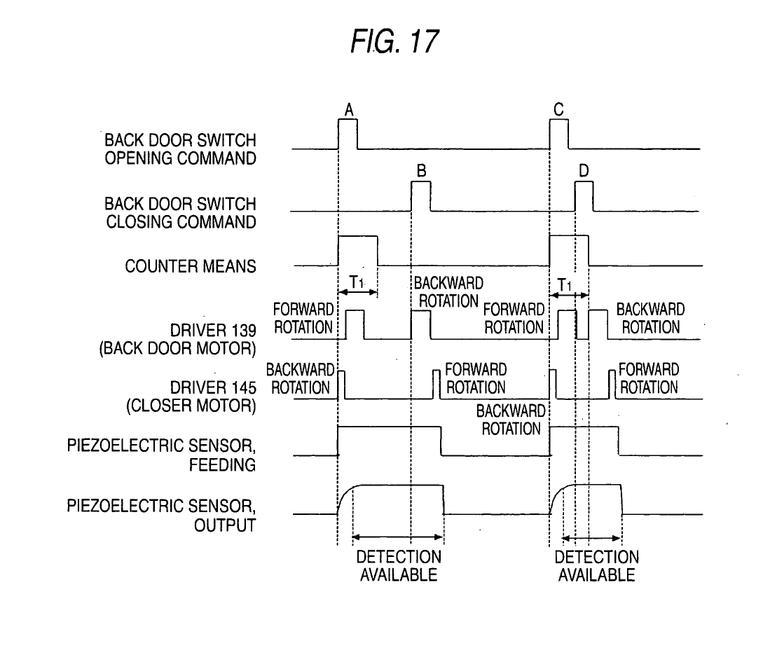

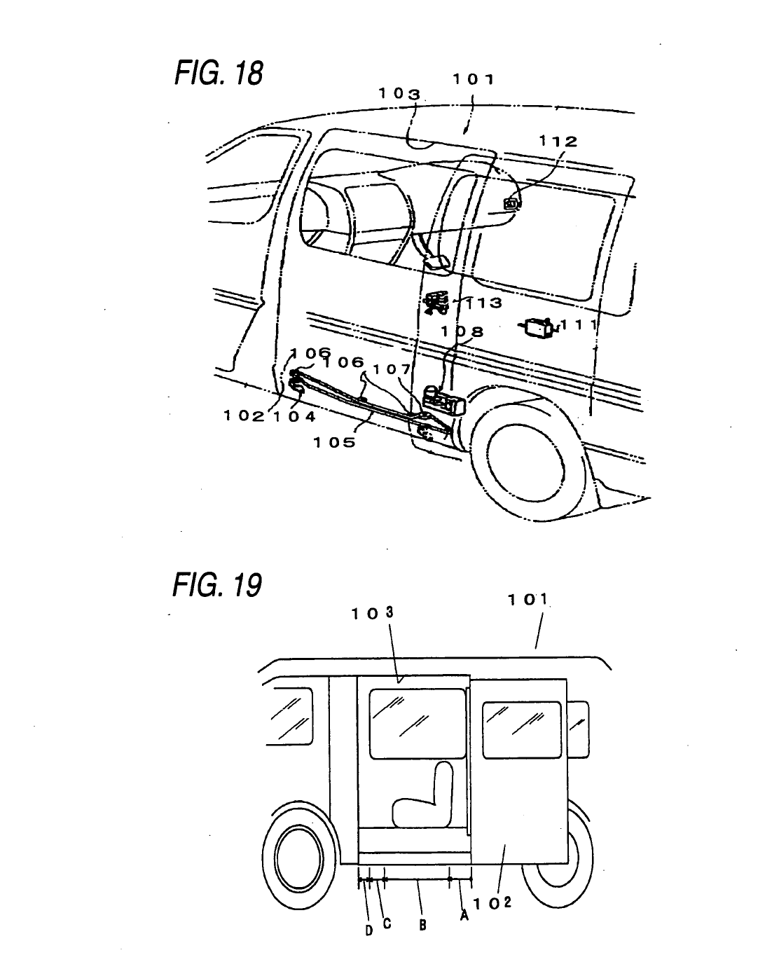

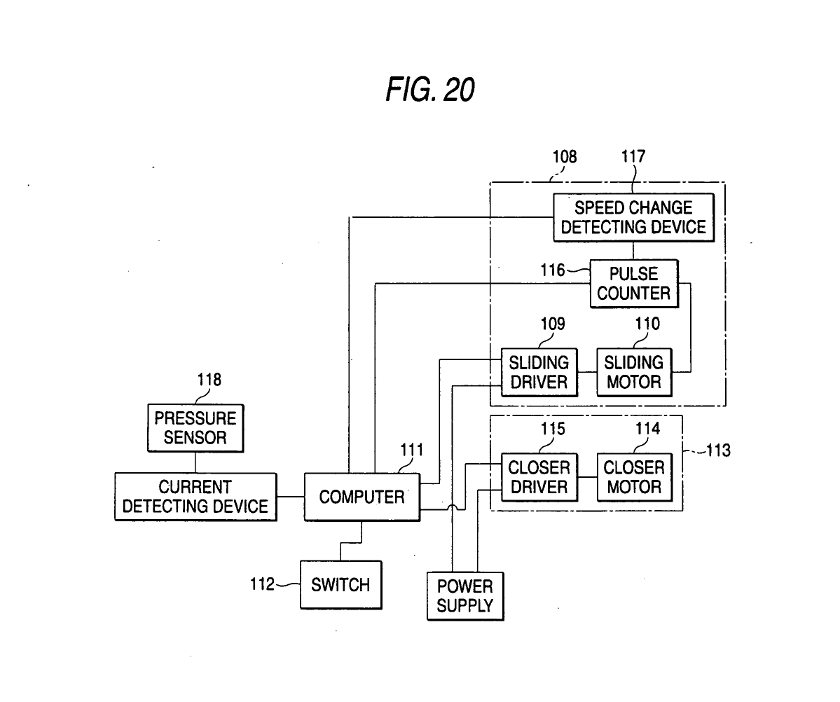

FIG. 17 is a time chart which shows how the control unit 138 controls under the system described heretofore.

The back door switch inputs a command A to open the back door and a command B to close the back door. This is normally a pair of operations, and since goods are loaded and unloaded in a state where the back door is opened, it is general that a sufficient time elapses between the door opening command A and the door closing command B.

The control unit rotates the closer motor backwards via the driver 109 by the door opening command A of the back door switch, whereby the back door is released from a closed position where the back door is locked. In connection with this, the counter means starts counting. Then, a predetermined period of time T1 is counted. Then, the back door motor is rotated forwards via the driver 103 so as to move the back door in an opening direction.

As has been described previously, since the sufficient time has elapsed between the normal opening and closing operations, this time T1 has elapsed completely at a point in time where the door closing command B is inputted. Consequently, the door closing command B is executed as it is, whereby the control unit rotates the back door motor backwards via the driver 103 so as to move the back door in the closing direction. Then, the control unit rotates the closer motor forwards via the driver 109 so as to lock the back door at the closed position.

The control unit starts feeding the piezoelectric sensor at a point in time where the control unit receives the door opening command A. An output from the piezoelectric sensor can be detected after a slight lapse of time as a rising time. While there is no risk that a trapping occurs while the back door is being opened, by energizing the sensor while the back door is being opened, and in particular, by utilizing the cable-shaped piezoelectric sensor for the sensor, it becomes possible to detect a contact of the back door with a human being, a foreign matter and part of a building such as a ceiling in the middle of opening the back door. Namely, since the back door vibrates largely due to such a contact, the piezoelectric sensor, which is a type of sensor for detecting vibrations, can detect the contact of the back door. In this case, since the control unit stops the back door motor via the driver 103 so as to interrupt the further movement of the door in the opening direction, it is extremely safe.

Next, how to control a case will be described in which a command C to open the back door and a command D to close the same door are inputted continuously within a short period of time.

Firstly, when the door opening command C is inputted, the command is executed as it is, whereby the control unit rotates the closer motor backwards via the driver 9, so that the back door is released from the closed position where the back door is locked. In connection with this, the counter means starts counting. Then, the predetermined period of time TI is counted. Next, the back door motor is rotated forwards via the driver 3 so as to drive the back door in the opening direction.

In relation to the door closing command D that is inputted in succession, since the counter means has not completed the counting of the predetermined period of time T1, the operation to open the back door is delayed until the time T1 has elapsed. Namely, at a point in time where T1 has elapsed, the control unit rotates the back door motor backwards via the driver 103 so as to drive the back door in the closing direction. Then, the control unit rotates the closer motor forwards via the driver 109, whereby the back door is locked at the closed position.

Here, the predetermined period of time T1 that is counted by the counter means is set to a time to produce an opening, for example, a space of several tens of centimeters or larger, which is enough for the driver to confirm whether or not there is standing a person behind the opening back door or whether or not there exists a situation which would trigger a collision and a trapping when he or she turns around to see backwards from the driver's seat.

By this configuration, the driver is allowed to see outside the door for confirmation when he or she gives an abrupt command to close the door while it is being opened, there by making it possible to prevent a risk of trapping by the door.

In addition, by providing the flexible cable-shaped piezoelectric sensor, together with the delayed door closing operation, the detection of a trapping by the door can be ensured by detecting the vibration of the door by the piezoelectric sensor.

(Embodiment 6)

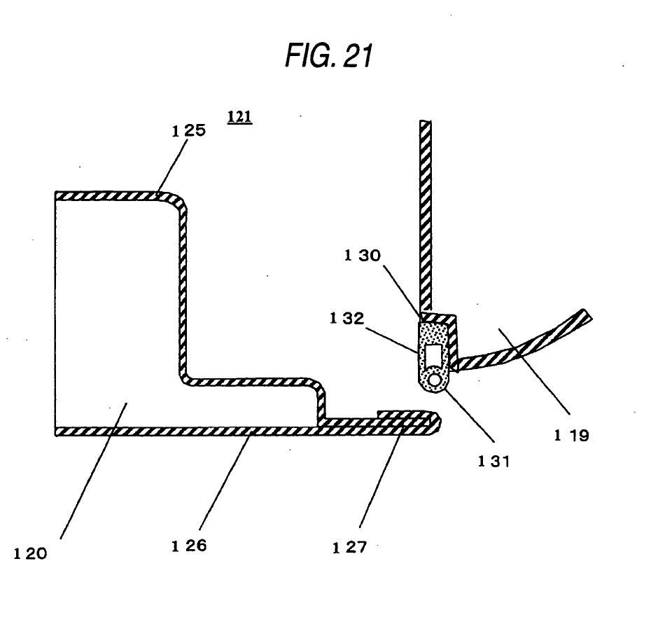

FIG. 21 shows a movable body opening and closing control apparatus according to Embodiment 6 of the invention, and since the basic configuration and function thereof are the same as those of Embodiment 5, only what is different from Embodiment 1 will be described.

In Embodiment 6, what is different from Embodiment 5 resides in that a sensor is provided on a cross section taken along the line B-B in FIG. 13. Namely, the sensor is provided not on the side of the movable body but on the vehicle body which constitutes a fixed side.

In this configuration, since the sensor is provided on the fixed side, the sensor is made difficult to be affected by vibrations of the door generated when the door is opened and closed, thereby making it possible to expect a stable detection.

(Embodiment 7)

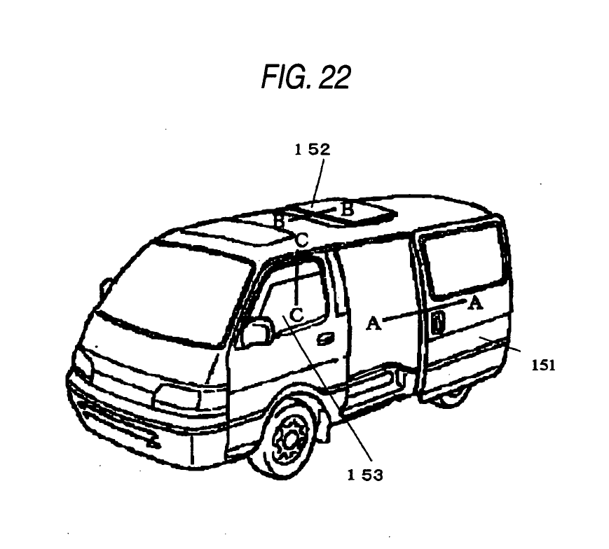

FIG. 22 shows a movable body opening and closing control apparatus according to Embodiment 7 of the invention, and since the basic configuration and function thereof are the same as those of Embodiment 5, only what is different from Embodiment 1 will be described.

As shown in the figure, a piezoelectric sensor can be provided on a cross section at one end of a sliding door 151 which is taken along the line A-A. In addition, the invention can be similarly applied to a cross section of a sunroof 152 which is taken along the line B-B. Furthermore, the invention can also be provided on a cross section of a power window 153 which is taken along the line C-C.

In these configurations, the invention can widely be applied not only to the back door but also to the sliding door, sunroof and power window.

(Embodiment 8)

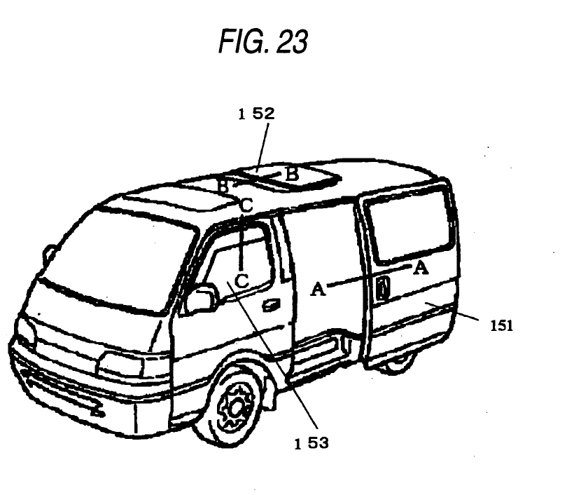

FIG. 23 shows a movable body opening and closing control apparatus according to Embodiment 8 of the invention, and since the basic configuration and function thereof are the same as those of Embodiment 5, only what is different from Embodiment 1 will be described.

Instead of the predetermined period of time T1 which is counted by the counter means in Embodiment 1, there is provided a function to detect whether or not a door has been opened to such an extent that the door has passed a predetermined opened position. Reference numeral 154 denotes a photoelectric switch for performing the function, and a control unit detects at least whether or not a movable body (in this embodiment, a sliding door ) 151 has been opened to such an extent that the movable body has passed a predetermined opened position by the photoelectric switch 154.

In the event that the movable body is determined by the function to detect the opened position as not having been opened to such an extent that the movable body has passed the predetermined opened position when a command to close the movable body is given from the input means in the middle of opening the door, the control unit controls such that a closing operation is delayed until the movable body has reached the predetermined opened position.

By this configuration, the driver is allowed to see outside the door for confirmation against an abrupt command to close the door while it is being opened, thereby making it possible to prevent a risk of trapping by the door.

While the invention has been described heretofore in detail and by reference to the specific embodiments, it is obvious to those skilled in the art that various changes and modifications can be imparted thereto without departing from the spirit and scope of the invention.

This patent application is based upon the Japanese Patent Application No. 2003-13691 filed on May 15, 2003 and the Japanese Patent Application No. 2003-136970 filed on May 15, 2003, and the contents thereof are to be incorporated herein by reference.

### INDUSTRIAL APPLICABILITY

As has been described heretofore, according to the movable body opening and closing control apparatus, since the control unit is configured so as to control such that when the command to close the movable body is generated from the input means while the movable body is being opened, the closing operation is delayed until the movable body has reached the predetermined opened position, the operator is allowed to see outside the movable body for confirmation against the abrupt command to close the movable body in the middle of opening the movable body, whereby there is provided an advantage that a trapping by the movable body can be prevented.

In addition, in the movable body opening and closing control apparatus of the invention, since the movable body is made to constitute the sliding door or the back door which is provided on the automobile, the input means is provided on the driver's seat of the automobile and the control unit is made to control such that when the command to close the movable body is generated from the input means while the movable body is being opened, the closing operation is delayed until the movable body has been opened to such an extent that the outside of the vehicle can be seen from the driver's seat, the driver is allowed to see outside the movable body for confirmation against the abrupt command to close the movable body in the middle of opening the movable body, whereby there is provided an advantage that a trapping by the movable body can be prevented.

In addition, in the movable body opening and closing control apparatus of the invention, since the flexible cable-shaped piezoelectric sensor is used as the sensor, the detection of a trapping by the door can be ensured by detecting the vibration of the relevant door by the piezoelectric sensor, together with the delayed door closing operation.

Additionally, in the movable body opening and closing control apparatus of the invention, since the control unit has the counter means which is adapted to start counting at the point in time where the opening command is generated from the input means and is made to control such that the sending of the closing operation command to the drive means is delayed until the counter means has counted the predetermined period of time even when the command to close the movable body is generated, the delay of the predetermined period of time can easily be realized by means of, for example, the software of the microcomputer which constitutes the control unit.

In addition, in the movable body opening and closing control apparatus, since the sensor includes the detection circuit having the filter which removes noise and the control unit has the counter means which is adapted to start counting at the point in time where the opening command is generated from the input means and is made to control such that the sending of the closing operation command to the drive means is delayed at least until the counter means has counted the predetermined period of time which exceeds the rising time based on the time constant of the detection circuit even when the command to close the movable body is generated, the sensor can detect the generation of a trapping between the movable body and the main body in a more ensured fashion, so that the closing operation can be implemented safely.

Additionally, according to the movable body opening and closing control apparatus of the invention, since the control unit is configured so as to control such that when the command to close the movable body is generated from the input means while the movable body is being opened, the closing operation is delayed until the movable body has reached the predetermined opened position, the operator is allowed to see outside the movable body for confirmation against the abrupt command to close the movable body in the middle of opening the movable body, whereby there is provided an advantage that a trapping by the movable body can be prevented.

In addition, in the movable body opening and closing control apparatus of the invention, since the movable body is made to constitute the sliding door or the back door which is provided on the automobile, the input means is provided on the driver's seat of the automobile and the control unit is made to control such that when the command to close the movable body is generated from the input means while the movable body is being opened, the closing operation is delayed until the movable body has been opened to such an extent that the outside of the vehicle can be seen from the driver's seat, the driver is allowed to see outside the movable body for confirmation against the abrupt command to close the movable body in the middle of opening the movable body, whereby there is provided an advantage that a trapping by the movable body can be prevented.

Additionally, in the movable body opening and closing control apparatus of the invention, since the control unit has the counter means which is adapted to start counting at the point in time where the opening command is generated from the input means and is made to control such that the sending of the closing operation command to the drive means is delayed until the counter means has counted the predetermined period of time even when the command to close the movable body is generated, the delay of the predetermined period of time can easily be realized by means of, for example, the software of the microcomputer which constitutes the control unit.

In addition, in the movable body opening and closing control apparatus of the invention, since the control unit includes the function to detect whether or not the movable body has been opened to such an extent that the movable body has passed at least the predetermined opened position and is made to control such that in the event that the movable body is determined by the function to detect the opened position as not having been opened to such an extent that the movable body has passed the predetermined opened position when the command to close the movable body is generated from the input means in the middle of opening the door, the closing operation is delayed until the movable body has reached the predetermined opened position, the detection of the predetermined period of time can easily be realized by, for example, a switching means such as a photoelectric switch.

1. A movable body opening and closing control apparatus comprising:
a movable body provided in an opening in a main body in such a manner as to be freely opened and closed;
drive means for driving the movable body, input means for commanding the movable body to be opened and closed;
detecting means for detecting a contact of an object between the movable body and the main body; and
a control unit for controlling the opening and closing of the movable body, wherein when a command to close the movable body is generated from the input means while the movable body is being opened, the control unit controls such that a closing operation is delayed until the movable body reaches a predetermined opened position.

2. A movable body opening and closing control apparatus as set forth in claim 1, wherein the movable body constitutes a sliding door or a back door provided on an automobile, the input means is provided on a driver's seat of the automobile, and the control unit controls such that when a command to close the sliding door or the back door is generated from the input means while the sliding door or the back door is being opened, a closing operation is delayed until the movable body reaches a position where the outside of the automobile can be seen from the driver's seat.

3. A movable body opening and closing control apparatus as set forth in claim 1, wherein a flexible cable-shaped piezoelectric sensor is used as the detecting means.

4. A movable body opening and closing control apparatus as set forth in claim 1, wherein the control unit has counter means adapted to start counting at a point in time where an opening command is generated from the input means and is made to control such that even when a command to close the movable body is generated, the sending of a command to start a closing operation to the driving means is delayed until the counter means completes the counting of a predetermined period of time.

5. A movable body opening and closing control apparatus as set forth in claim 1, wherein the detecting means includes a detection circuit having a filter for removing noise, and the control unit has a counter means adapted to start counting at a point in time where an opening command is generated from the input means and is made to control such that even when a command to close the movable body is generated, the sending of a command to start a closing operation to the driving means is delayed at least until the counter means completes the counting of a predetermined period of time which exceeds a rising time based on a time constant of the detection circuit.

6. A movable body opening and closing control apparatus comprising:
a movable body provided in an opening in a main body in such a manner as to be freely opened and closed;
drive means for driving the movable body, input means for commanding the movable body to be opened and closed;
detecting means for detecting a contact of an object between the movable body and the main body; and
a control unit for controlling the opening and closing of the movable body,
wherein the control unit has a counter means adapted to start counting at a point in time where an opening command is generated from the input means and is made to control such that even when commands to close the movable body are generated in succession, a closing operation is delayed until the counter means completes the counting of a predetermined period of time.

7. A movable body opening and closing control apparatus comprising:
a movable body provided in an opening in a main body in such a manner as to be freely opened and closed;
drive means for driving the movable body, input means for commanding the movable body to be opened and closed; and
a control unit adapted to control such that when a command to close the movable body is generated from the input means while the movable body is being opened, a closing operation is delayed until the movable body reaches a predetermined opened position.

8. A movable body opening and closing control apparatus as set forth in claim 7, wherein the movable body constitutes a sliding door or a back door provided on an automobile, the input means is provided on a driver's seat of the automobile, and the control unit controls such that when a command to close the sliding door or the back door is generated from the input means while the sliding door or the back door is being opened, a closing operation is delayed until the movable body reaches a position where the outside of the automobile can be seen from the driver's seat.

9. A movable body opening and closing control apparatus as set forth in claim 7, wherein the control unit has counter means adapted to start counting at a point in time where an opening command is generated from the input means and is made to control such that even when a command to close the movable body is generated, the sending of a command to start a closing operation to the driving means is delayed until the counter means completes the counting of a predetermined period of time.

10. A movable body opening and closing control apparatus as set forth in claim 7, wherein the control unit has a function to detect whether or not the movable body has been opened to such an extent that the movable body has passed at least the predetermined opened position and is made to control such that in the event that the movable body is determined by the function to detect the opened position as not having been opened to such an extent that the movable body has passed the predetermined opened position when a command to close the movable body is generated from the input means in the middle of opening the movable body, a closing operation is delayed until the movable body reaches the predetermined opened position.
